(19) United States
(12) Patent Application Publication
(10) Pub. No.: US 2026/0115884 A1
(43) Pub. Date: Apr. 30, 2026

(54) WRENCH STRUCTURE

(71) Applicant: Chia-Kuan Liao, Taichung City (TW)

(72) Inventor: Chia-Kuan Liao, Taichung City (TW)

(21) Appl. No.: 18/928,017

(22) Filed: Oct. 26, 2024

(51) Int. Cl. B25G 1/10; B25B 13/04; B25B 13/08

(52) U.S. Cl. CPC B25G 1/102; B25B 13/04; B25B 13/08

(57) ABSTRACT

A wrench structure includes a wrench body provided with a handle. The handle is provided with four first faces, four first recessed portions, four projections, a second face, two second recessed portions, eight ribs, two first side faces, two second side faces, and a first guide angle. The handle has a first width, a second width, a third width, a fourth width, a fifth width, and a sixth width. The first width is more than the fourth width. The fourth width is more than the fifth width. The fifth width is more than the third width. The third width is more than the second width. The second width is more than the sixth width. The handle has a first thickness, a second thickness, a third thickness, and a fourth thickness.

### BACKGROUND OF THE INVENTION

### Field of the Invention

The present invention relates to a hand operated tool and, more particularly, to a wrench structure.

### Description of the Related Art

A conventional wrench was disclosed in the applicant's U.S. Patent Publication No. 2018/0015609, and comprises a handle 11 provided with a first block 113. The first block 113 protrudes from the top and the bottom of the first face 111. The handle 11 has a first length 31. The maximum length of the first block 113 defines a second length 32. A proportion of the first length 31 and the second length 32 is ranged between four to one (4:1) and two to one (2:1). The handle 11 has a first thickness 33. The minimum thickness of the recess 112 defines a second thickness 34. The first block 113 has a third thickness 35. Thus, the first block 113 has the second length 32 and the third thickness 35 so that the first block 113 increases the maximum rotation torque of the handle 11. However, the handle 11 does not have any holding portion to support the user's hand so that when the user holds the handle 11, the user's hand easily slips from the handle 11.

### BRIEF SUMMARY OF THE INVENTION

The primary objective of the present invention is to provide a wrench structure providing a better support for a user's hand to facilitate the user holding the wrench structure.

In accordance with the present invention, there is provided a wrench structure comprising a wrench body. The wrench body is provided with a handle. The handle is provided with four first faces, four first recessed portions, four projections, a second face, two second recessed portions, eight ribs, two first side faces, two second side faces, and a first guide angle. The handle has a first width, a second width, a third width, a fourth width, a fifth width, and a sixth width. The first width is more than the fourth width. The fourth width is more than the fifth width. The fifth width is more than the third width. The third width is more than the second width. The second width is more than the sixth width. The handle has a first thickness, a second thickness, a third thickness, and a fourth thickness.

According to the primary advantage of the present invention, the handle is provided with the first recessed portions, the projections, and the second recessed portion. Thus, the first recessed portions reduce the weight of the handle, the second recessed portion also reduces the weight of the handle, and the projections increase the rotation torque when the handle is rotated, so that the handle has a balance between the weight and the rotation torque.

According to another advantage of the present invention, the handle is provided with eight ribs so that the handle has a structural rotation toughness.

According to a further advantage of the present invention, the handle has a reduced weight, increases the rotation torque, and has a rotation toughness by provision of the first recessed portions, the projections, the second recessed portion, and the ribs.

According to a further advantage of the present invention, the handle has a reduced weight, has an enhanced rotation torque, has an increased rotation toughness, and facilitates the user holding the wrench structure.

### BRIEF DESCRIPTION OF THE SEVERAL VIEWS OF THE DRAWING(S)

FIG. 1 is a perspective view of a wrench structure in accordance with the first preferred embodiment of the present invention.

FIG. 2 is a top view of the wrench structure as shown in FIG. 1.

FIG. 3 is a front cross-sectional view of the wrench structure taken along line A-A as shown in FIG. 2.

FIG. 4 is a perspective view of a wrench structure in accordance with the second preferred embodiment of the present invention.

FIG. 5 is a perspective view of a wrench structure in accordance with the third preferred embodiment of the present invention.

FIG. 6 is a perspective view of a wrench structure in accordance with the fourth preferred embodiment of the present invention.

FIG. 7 is a perspective view of a wrench structure in accordance with the fifth preferred embodiment of the present invention.

FIG. 8 is a perspective view of a wrench structure in accordance with the sixth preferred embodiment of the present invention.

FIG. 9 is a perspective view of a wrench structure in accordance with the seventh preferred embodiment of the present invention.

FIG. 10 is a perspective view of a wrench structure in accordance with the eighth preferred embodiment of the present invention.

FIG. 11 is a perspective view of a wrench structure in accordance with the ninth preferred embodiment of the present invention.

FIG. 12 is a perspective view of a wrench structure in accordance with the tenth preferred embodiment of the present invention.

### DETAILED DESCRIPTION OF THE INVENTION

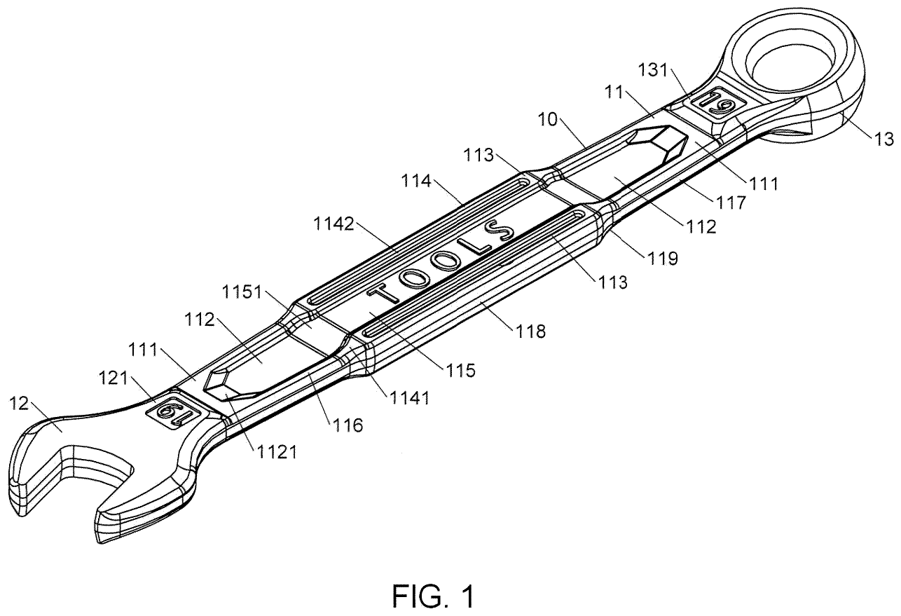

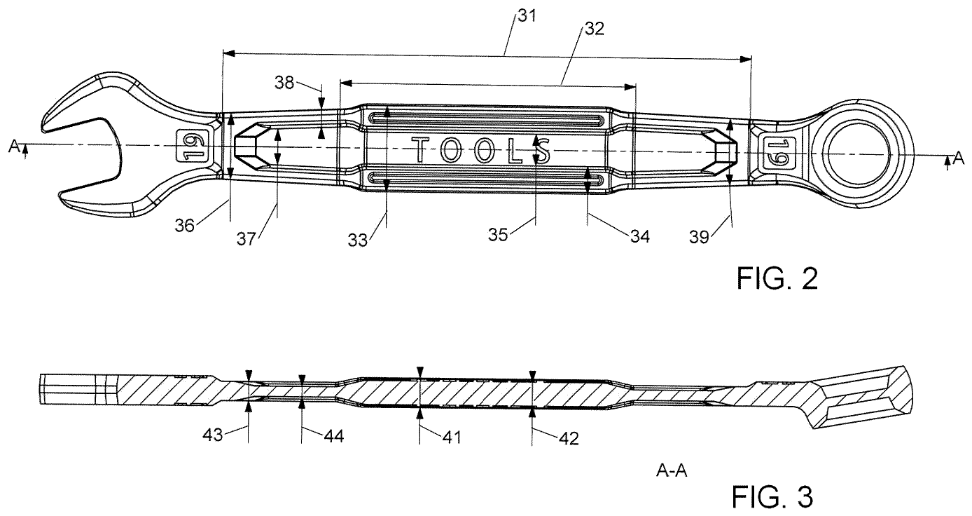

Referring to the drawings and initially to FIGS. 1-3, a wrench structure in accordance with the preferred embodiment of the present invention comprises a wrench body 10. The wrench body 10 is provided with a handle (or grip) 11. The handle 11 has a top and a bottom each provided with two first faces 111 formed on two ends thereof. Thus, the handle 11 has four first faces 111. Each of the first faces 111 has a planar shape. The first faces 111 of the top of the handle 11 coincide with each other, and the first faces 111 of the bottom of the handle 11 coincide with each other. The first faces 111 of the top of the handle 11 are parallel with the first faces 111 of the bottom of the handle 11. Each of the top and the bottom of the handle 11 is provided with two first recessed portions 112. Thus, the handle 11 has four first recessed portions 112. Each of the first recessed portions 112 is situated in one of the first faces 111. Each of the first recessed portions 112 is a groove. A first connecting portion 1121 is formed between each of the first recessed portions 112 and one of the first faces 111. The first connecting portion 1121 smoothly connects each of the first recessed portions 112 and one of the first faces 111. The first connecting portion 1121 is an inclined face or an arcuate face.

Each of the top and the bottom of the handle 11 is provided with two projections 113 located at a center of the handle 11. Thus, the handle 11 has four projections 113. Each of the projections 113 has a rectangular shape. The first faces 111 are arranged symmetrically relative to the projections 113, and the first recessed portions 112 are arranged symmetrically relative to the projections 113. The projections 113 are disposed between the first faces 111 and are disposed between the first recessed portions 112. Each of the projections 113 has a second face 114. The second face 114 has a planar shape. The second face 114 protrudes from each of the first faces 111. A second connecting portion 1141 is formed between the second face 114 and one of the first faces 111. The second connecting portion 1141 smoothly connects the second face 114 and one of the first faces 111. The second connecting portion 1141 is an inclined face or an arcuate face. The second face 114 is provided with a slot 1142 filled with various color or pigments.

Each of the top and the bottom of the handle 11 is provided with a second recessed portion 115 located at the center of the handle 11 and disposed between the projections 113. Thus, the handle 11 has two second recessed portions 115. The projections 113 are arranged symmetrically relative to the second recessed portion 115. The second recessed portion 115 has a planar shape. A third connecting portion 1151 is formed between the second recessed portion 115 and each of the first recessed portions 112. The third connecting portion 1151 smoothly connects the second recessed portion 115 and each of the first recessed portions 112. The third connecting portion 1151 is located between two second connecting portions 1141 which are arranged symmetrically relative to the third connecting portion 1151. The third connecting portion 1151 is an inclined face or an arcuate face.

The handle 11 is provided with eight ribs 116 which are arranged symmetrically relative to the four projections 113. Each of the first recessed portions 112 is defined between two of the ribs 116. The two of the ribs 116 are arranged symmetrically relative to each of the first recessed portions 112. Each of the ribs 116 has a first end connecting one of the first faces 111 and a second end connecting the second connecting portion 1141. The ribs 116 and the first faces 111 are co-planar.

Each of the first faces 111 has two first side faces 117. The first side faces 117 are perpendicular to the first faces 111. Each of the projections 113 has two second side faces 118. The two second side faces 118 protrude from the two first side faces 117. The second side faces 118 are perpendicular to the second face 114. A first guide angle (or corner) 119 is formed between each of the first side faces 117 and one of the second side faces 118. The first guide angle 119 has a round shape or an arcuate concave shape or an oblique shape.

The handle 11 has a first end provided with a first rotation portion 12. The first rotation portion 12 is an open end. The first rotation portion 12 is provided with two third faces 121 protruding from the first faces 111. Each of the third faces 121 connects one of the first faces 111. Each of the third faces 121 is provided with an indication (or marking) indicating a specification or a size of the wrench structure.

The handle 11 has a second end provided with a second rotation portion 13. The second rotation portion 13 is a box end. The second rotation portion 13 is provided with two fourth faces 131 protruding from the first faces 111. Each of the fourth faces 131 connects one of the first faces 111. Each of the fourth faces 131 is provided with an indication (or marking) indicating a specification or a size of the wrench structure.

The handle 11 has a first length 31 defined between the third faces 121 and the fourth faces 131. A second length 32 is defined by adding a length of each of the projections 113 and a length of the second connecting portion 1141. The first length 31 is more than the second length 32. The first length 31 is 1.5 times to two (or 2) times of the second length 32. Alternatively, the first length 31 is 1.6 times to 1.9 times of the second length 32. Alternatively, the first length 31 is 1.75 times of the second length 32.

A first width 33 is defined by the maximum width between the two projections 113. The first width 33 is defined between the two second side faces 118. The second face 114 has a second width 34. The second recessed portion 115 has a third width 35. A connection of the first rotation portion 12 and the handle 11 has a fourth width 36. The narrowest part of each of the first recessed portions 112 has a fifth width 37. Each of the ribs 116 has a sixth width 38. A connection of the second rotation portion 13 and the handle 11 has a seventh width 39. The seventh width 39 is close to or equal to the fourth width 36.

The first width 33 has the maximum value. The first width 33 is more than the fourth width 36. The fourth width 36 is more than the fifth width 37. The fifth width 37 is more than the third width 35. The third width 35 is more than the second width 34. The second width 34 is more than the sixth width 38.

A first thickness 41 is defined between the second faces 114. A second thickness 42 is defined between the two second recessed portions 115. A third thickness 43 is defined between two of the first faces 111. The third thickness 43 is close to the first rotation portion 12 or the second rotation portion 13. A fourth thickness 44 is defined between of two of the first recessed portions 112. The first thickness 41 has the maximum value. The first thickness 41 is more than the second thickness 42. The second thickness 42 is more than the third thickness 43. The third thickness 43 is more than the fourth thickness 44.

The first thickness 41 is 1.2 times to 1.3 times of the second thickness 42. The first thickness 41 is 1.4 times to 1.7 times of the third thickness 43 or 1.5 times to 1.6 times of the third thickness 43. The third thickness 43 is 1.7 times to two (or 2) times of the fourth thickness 44.

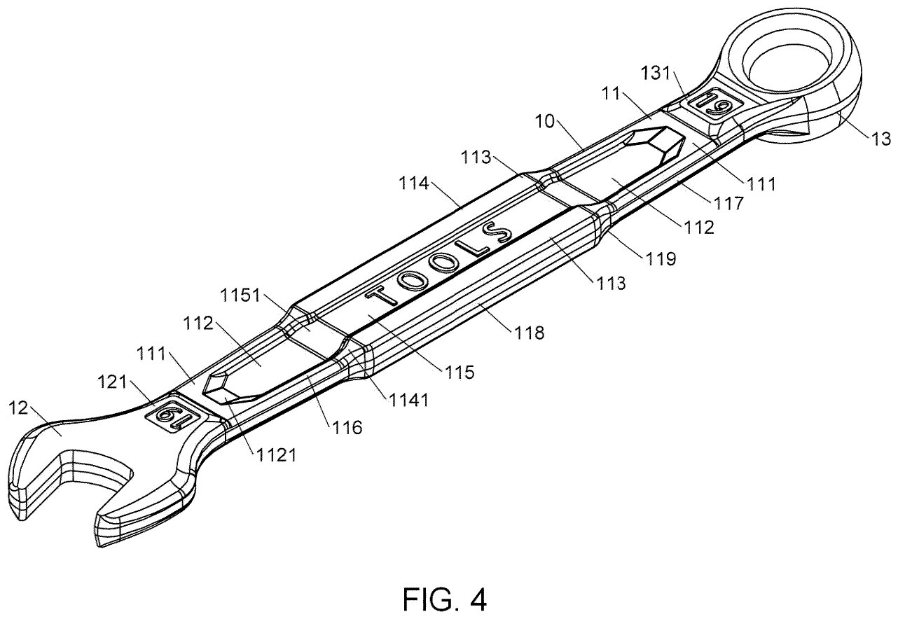

Referring to FIG. 4 with reference to FIG. 1, the slot 1142 of the second face 114 is undefined.

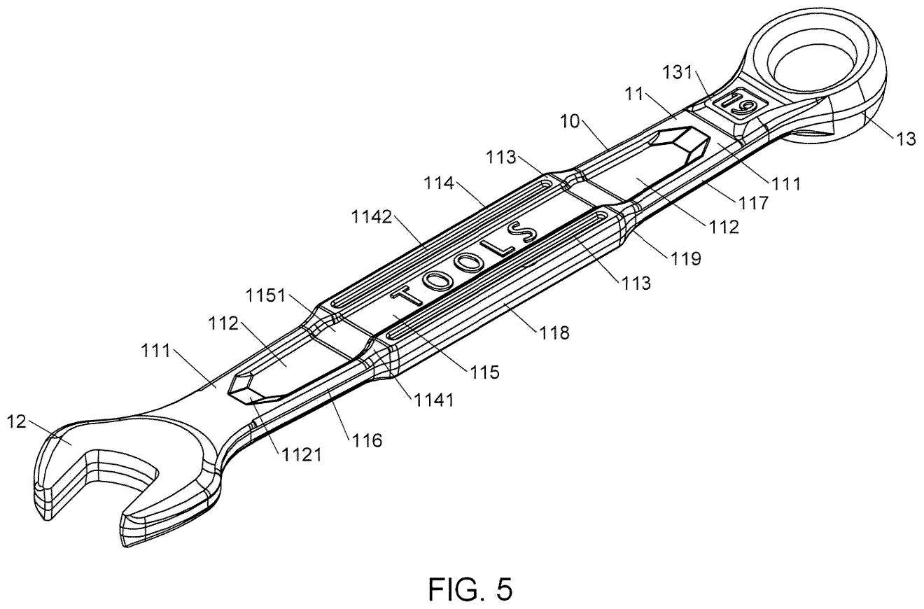

Referring to FIG. 5 with reference to FIG. 1, the indication of each of the third faces 121 is undefined.

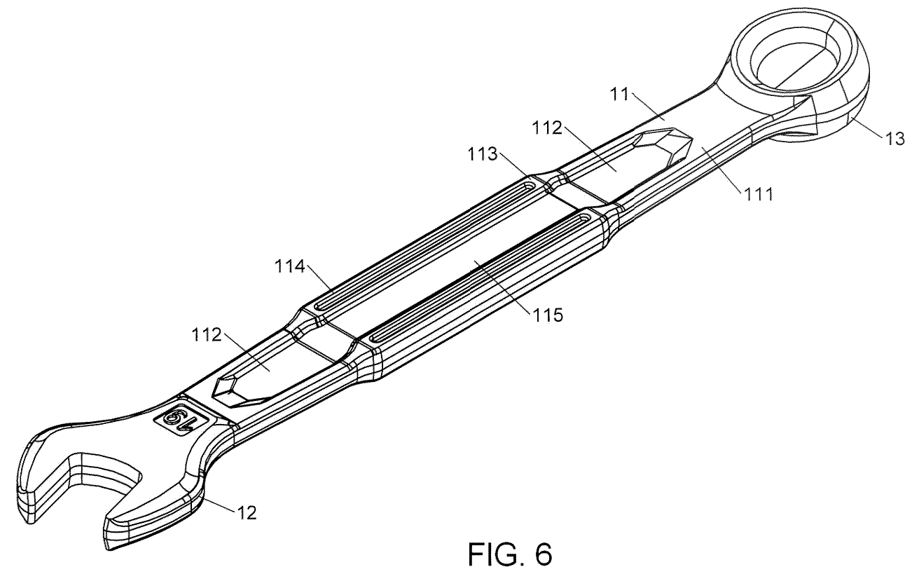

Referring to FIG. 6 with reference to FIG. 1, the indication of each of the fourth faces 131 is undefined.

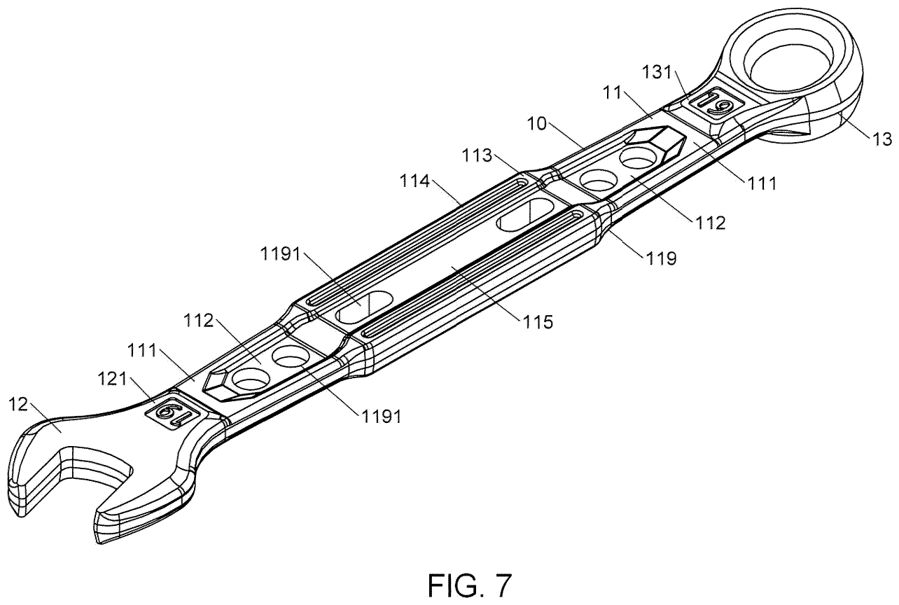

Referring to FIG. 7 with reference to FIG. 1, multiple grooves 1191 are formed in the first recessed portions 112 and the second recessed portion 115. Each of the grooves 1191 has a circular or elongate shape. Each of the grooves 1191 penetrates or partially penetrates the handle 11.

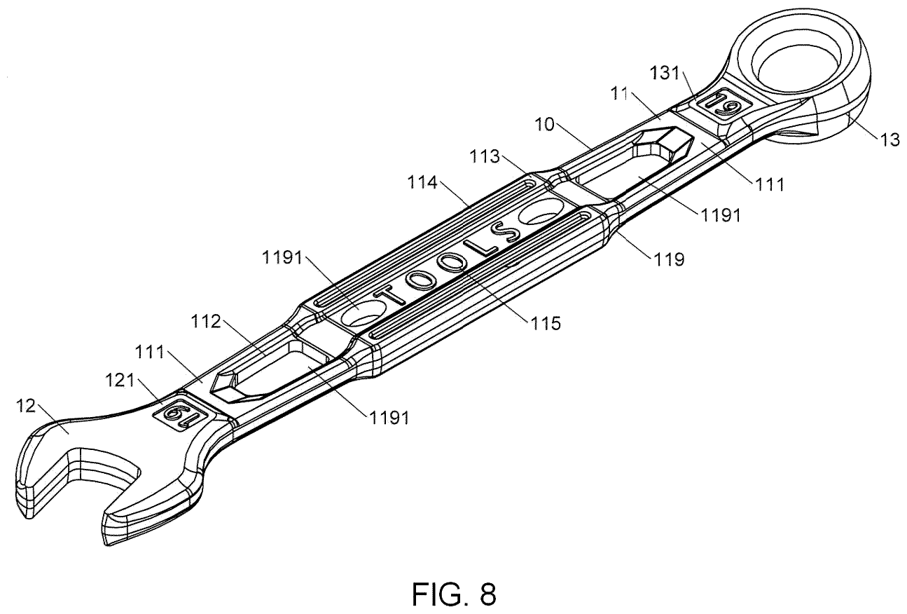

Referring to FIG. 8 with reference to FIG. 1, the grooves 1191 penetrate the handle 11.

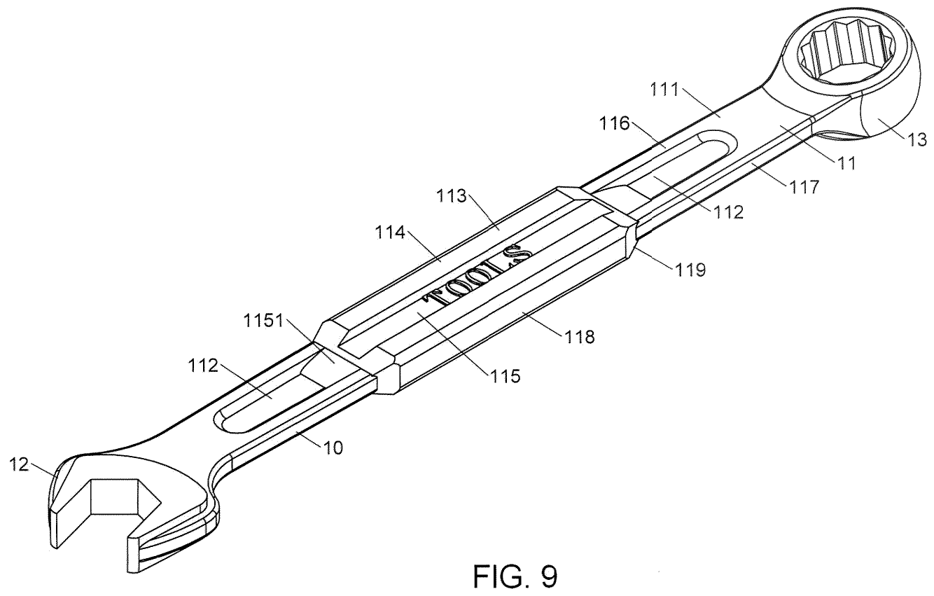

Referring to FIG. 9 with reference to FIG. 1, the slot 1142 of the second face 114 is undefined. Each of the first recessed portions 112 has an arcuate face distant from one of the projections 113 and close to the first rotation portion 12 or the second rotation portion 13.

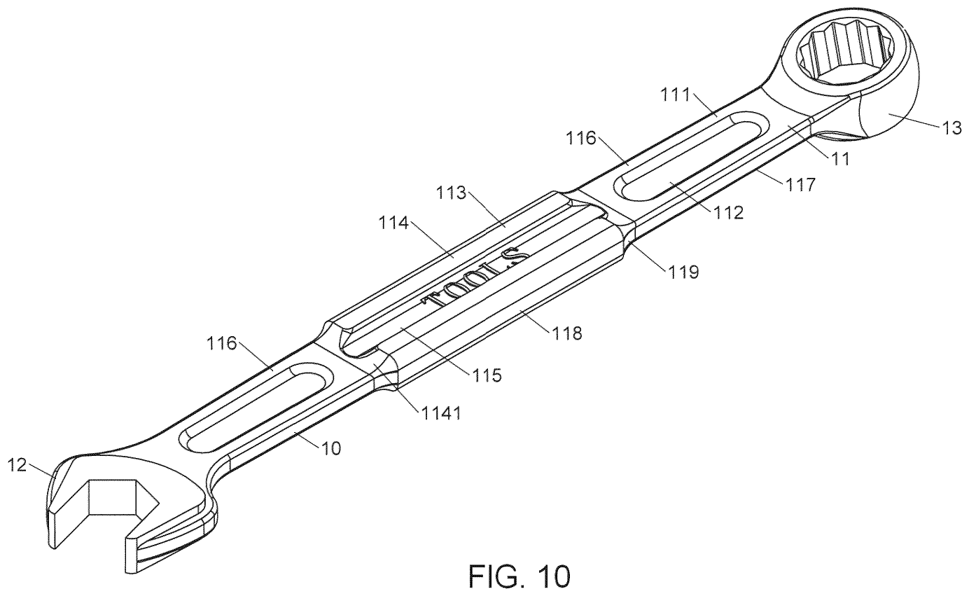

Referring to FIG. 10 with reference to FIG. 1, the slot 1142 of the second face 114 is undefined. The third connecting portion 1151 between the second recessed portion 115 and each of the first recessed portions 112 is undefined. Thus, each of the first recessed portions 112 is separated from the third connecting portion 1151.

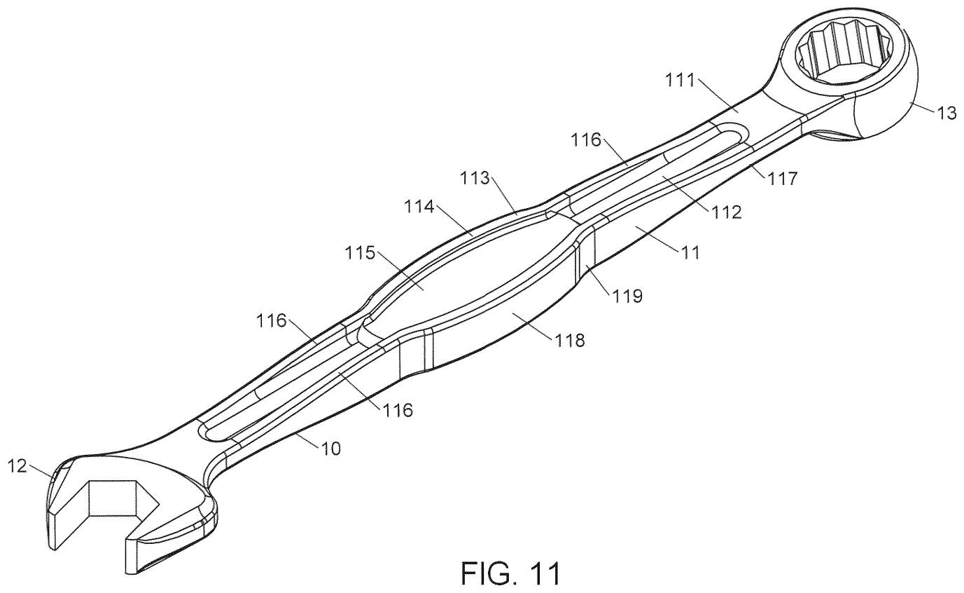

Referring to FIG. 11 with reference to FIG. 1, the slot 1142 of the second face 114 is undefined. Each of the second side faces 118 has a convex shape, and each of the ribs 116 is an inclined face and connects one of the projections 113 and one of the first faces 111.

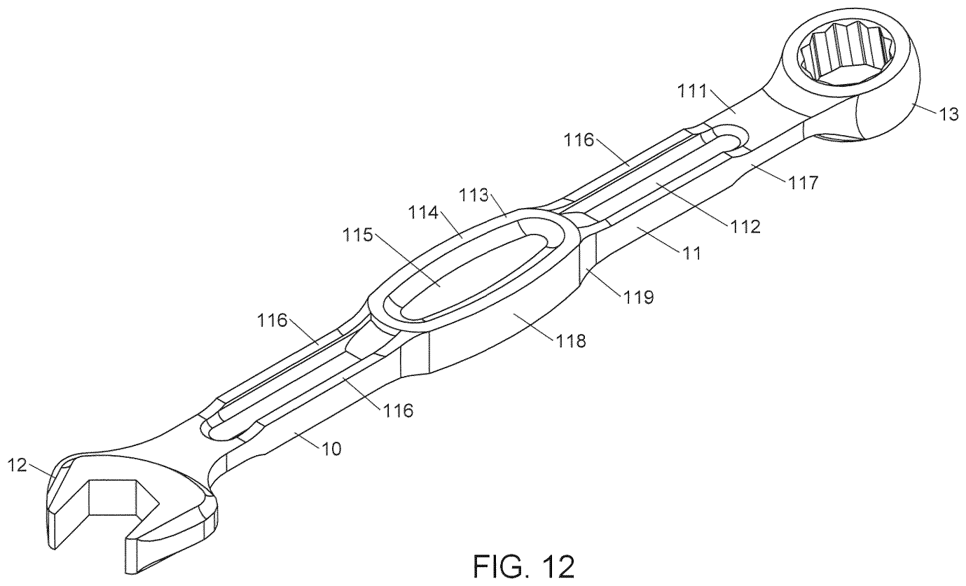

Referring to FIG. 12 with reference to FIG. 1, the slot 1142 of the second face 114 is undefined. Each of the ribs 116 protrudes from one of the first faces 111, so that each of the ribs 116 and one of the first faces 111 are not co-planar. A round or beveled guide angle is defined between each of the ribs 116 and one of the first faces 111. Each of the second side faces 118 has a convex shape.

In another preferred embodiment of the present invention, with reference to FIGS. 5 and 6, the indication of each of the third faces 121 is undefined, and the indication of each of the fourth faces 131 is undefined. The second recessed portion 115 is provided with multiple trademarks or patterns having a convex or concave shape. The trademarks or patterns are made by a printing process to have a planar shape.

Accordingly, the wrench structure of the present invention has the following advantages.
1. Each of the top and the bottom of the handle 11 is provided with the two first recessed portions 112. Each of the top and the bottom of the handle 11 is provided with the two projections 113. Each of the top and the bottom of the handle 11 is provided with the second recessed portion 115 located at the center of the handle 11 and disposed between the projections 113. Thus, the first recessed portions 112 reduce the weight of the handle 11, the second recessed portion 115 also reduces the weight of the handle 11, and the projections 113 increase the rotation torque when the handle 11 is rotated, so that the handle 11 has a balance between the weight and the rotation torque.
2. The handle 11 is provided with eight ribs 116. Any two of the ribs 116 are arranged on two sides of each of the first recessed portions 112. The ribs 116 have a rotation torque. Thus, the handle 11 has a structural rotation toughness by provision of the first recessed portions 112 and the ribs 116 so that the handle 11 is not broken easily during rotation.
3. The handle 11 defines the first thickness 41, the second thickness 42, the third thickness 43, and the fourth thickness 44. Thus, the handle 11 has different thickness at different positions, so that the handle 11 has a reduced weight, has an enhanced rotation torque, and has an enhanced rotation toughness.
4. The handle 11 has a reduced weight, increases the rotation torque, and has a rotation toughness by provision of the first recessed portions 112, the projections 113, the second recessed portion 115, and the ribs 116. Thus, the wrench structure has three structural benefits.
5. When the wrench body 10 is driven and rotated, the user's thumb rests on the first guide angle 119 which facilitates the user operating and rotating the handle 11.
6. The projections 113 have the first thickness 41 which is more than the third thickness 43. Thus, when the user's hand holds the wrench structure, the user's thumb rests on the second connecting portions 1141 and the third connecting portion 1151 to operate and rotate the handle 11 easily.
7. When the user's hand holds the wrench structure, the user's thumb rests on the second connecting portions 1141 and the third connecting portion 1151 or rests on the first guide angle 119, so that the handle 11 is driven and rotated easily and conveniently.
8. When the user holds the handle 11, the user's thumb presses the projections 113, rests on the second connecting portions 1141 and the third connecting portion 1151, or abuts on the first guide angle 119 according to the practical requirement.
9. The handle 11 defines the first thickness 41, the second thickness 42, the third thickness 43, the fourth thickness 44, the first width 33, the second width 34, the third width 35, the fourth width 36, the fifth width 37, the sixth width 38, and the seventh width 39, so that the handle 11 has a reduced weight, has an enhanced rotation torque, has an increased rotation toughness, and facilitates the user holding the wrench structure.
10. The handle 11 is provided with the first faces 111, the first recessed portions 112, the projections 113, the second face 114, the second recessed portion 115, the ribs 116, the first side faces 117, and the second side faces 118. Thus, the handle 11 has various structural designs and has a three-dimensional appearance, thereby enhancing the aesthetic quality of the wrench structure.

1. A wrench structure comprising:
a wrench body;
wherein:
the wrench body is provided with a handle;
the handle has a top and a bottom each provided with two first faces;
the handle has four first faces;
each of the first faces has a planar shape;
the first faces of the top of the handle coincide with each other, and the first faces of the bottom of the handle coincide with each other;
the first faces of the top of the handle are parallel with the first faces of the bottom of the handle;
each of the top and the bottom of the handle is provided with two first recessed portions;
the handle has four first recessed portions;
each of the first recessed portions is situated in one of the first faces;
each of the first recessed portions is a groove;
a first connecting portion is formed between each of the first recessed portions and one of the first faces;
the first connecting portion smoothly connects each of the first recessed portions and one of the first faces;
each of the top and the bottom of the handle is provided with two projections located at a center of the handle;
the handle has four projections;
each of the projections has a rectangular shape;
the first faces are arranged symmetrically relative to the projections, and the first recessed portions are arranged symmetrically relative to the projections;
the projections are disposed between the first faces and are disposed between the first recessed portions;
each of the projections has a second face;
the second face protrudes from each of the first faces;
a second connecting portion is formed between the second face and one of the first faces;
the second connecting portion smoothly connects the second face and one of the first faces;
each of the top and the bottom of the handle is provided with a second recessed portion located at the center of the handle and disposed between the projections;
the handle has two second recessed portions;
the projections are arranged symmetrically relative to the second recessed portion;
a third connecting portion is formed between the second recessed portion and each of the first recessed portions;
the third connecting portion smoothly connects the second recessed portion and each of the first recessed portions;
the third connecting portion is located between two second connecting portions which are arranged symmetrically relative to the third connecting portion;
the handle is provided with eight ribs which are arranged symmetrically relative to the four projections;
each of the first recessed portions is defined between two of the ribs;
the two of the ribs are arranged symmetrically relative to each of the first recessed portions;
each of the ribs has a first end connecting one of the first faces and a second end connecting the second connecting portion;
the ribs and the first faces are co-planar;
each of the first faces has two first side faces;
each of the projections has two second side faces;
the two second side faces protrude from the two first side faces;
a first guide angle is formed between each of the first side faces and one of the second side faces;
the handle has a first length defined between the third faces and the fourth faces;
a second length is defined by adding a length of each of the projections and a length of the second connecting portion;
the first length is more than the second length;
a first width is defined by the maximum width between the two projections;
the first width is defined between the two second side faces;
the second face has a second width;
the second recessed portion has a third width;
a connection of the first rotation portion and the handle has a fourth width;
the narrowest part of each of the first recessed portions has a fifth width;
each of the ribs has a sixth width;
a connection of the second rotation portion and the handle has a seventh width;
the seventh width is close to or equal to the fourth width;
the first width has the maximum value;
the first width is more than the fourth width; The fourth width is more than the fifth width;
the fifth width is more than the third width;
the third width is more than the second width;
the second width is more than the sixth width;
a first thickness is defined between the second faces;
a second thickness is defined between the two second recessed portions;
a third thickness is defined between two of the first faces;
the third thickness is close to the first rotation portion or the second rotation portion;
a fourth thickness is defined between of two of the first recessed portions;
the first thickness has the maximum value;
the first thickness is more than the second thickness;
the second thickness is more than the third thickness; and
the third thickness is more than the fourth thickness.

2. The wrench structure as claimed in claim 1, wherein:
the first connecting portion is an inclined face or an arcuate face;
the second face has a planar shape;
the second connecting portion is an inclined face or an arcuate face;
the second face is provided with a slot filled with various color or pigments;
the second recessed portion has a planar shape;
the third connecting portion is an inclined face or an arcuate face;
the first side faces are perpendicular to the first faces;
the second side faces are perpendicular to the second face; and
the first guide angle has a round shape or an arcuate concave shape or an oblique shape.

3. The wrench structure as claimed in claim 1, wherein:
the handle has a first end provided with a first rotation portion;
the first rotation portion is an open end;
the first rotation portion is provided with two third faces protruding from the first faces;
each of the third faces connects one of the first faces;
each of the third faces is provided with an indication indicating a specification or a size of the wrench structure;
the handle has a second end provided with a second rotation portion;
the second rotation portion is a box end;
the second rotation portion is provided with two fourth faces protruding from the first faces;
each of the fourth faces connects one of the first faces; and
each of the fourth faces is provided with an indication indicating a specification or a size of the wrench structure.

4. The wrench structure as claimed in claim 1, wherein:
the first length is 1.5 times to two times of the second length, or the first length is 1.6 times to 1.9 times of the second length, or the first length is 1.75 times of the second length;
the first thickness is 1.2 times to 1.3 times of the second thickness, or the first thickness is 1.4 times to 1.7 times of the third thickness or 1.5 times to 1.6 times of the third thickness;
the third thickness is 1.7 times to two times of the fourth thickness.

5. The wrench structure as claimed in claim 1, wherein:
multiple grooves are formed in the first recessed portions or the second recessed portion;
each of the grooves has a circular or elongate shape; and
each of the grooves penetrates or partially penetrates the handle.

6. The wrench structure as claimed in claim 1, wherein each of the first recessed portions has an arcuate face distant from one of the projections and close to the first rotation portion or the second rotation portion.

7. The wrench structure as claimed in claim 1, wherein the third connecting portion between the second recessed portion and each of the first recessed portions is undefined, and each of the first recessed portions is separated from the third connecting portion.

8. The wrench structure as claimed in claim 1, wherein each of the second side faces has a convex shape, and each of the ribs is an inclined face and connects one of the projections and one of the first faces.

9. The wrench structure as claimed in claim 1, wherein:
each of the ribs protrudes from one of the first faces, so that each of the ribs and one of the first faces are not co-planar;
a round or beveled guide angle is defined between each of the ribs and one of the first faces; and
each of the second side faces has a convex shape.
